(19) United States
(12) Patent Application Publication
(10) Pub. No.: US 2010/0196584 A1
(43) Pub. Date: Aug. 5, 2010

(54) CEREAL MOLDED SNACK

(75) Inventors: Jean Pierre Dupart, Lausanne (CH); Jun Xia Dai, Orbe (CH); Dhan Pal Sirohi, Pully (CH); Jean-Jacques Andre Desjardins, Yens (CH); Jean Fernand Horisberger, Ecublens (CH)

Correspondence Address: K&L Gates LLP, P.O. Box 1135, CHICAGO, IL, 60690, US

(73) Assignee: NESTEC S.A., Vevey (CH)

(21) Appl. No.: 12/602,600

(22) PCT Filed: Mar. 27, 2008
(86) PCT No.: PCT/EP2008/053682

§ 371 Date: Dec. 1, 2009

(30) Foreign Application Priority Data
Jun. 1, 2007 (EP) 07109432.0

(51) Int. Cl. A23L 1/164; A23P 1/10

(52) U.S. Cl. 426/625; 426/389

(57) ABSTRACT

The present invention concerns a cereal molded snack comprising cereal-based flakes agglomerated together with a mix of sugar and fat, wherein the flakes are mainly roller-dried flakes.

The present invention concerns a cereal molded snack, as well as a process for the manufacture of said snack.

It is already known to have a cereal composite material, like the product according to EP 326'253. This product is not a molded product. The objective of the invention disclosed in EP 326'253 is to reach a better water absorption and an improved texture, when used in a low fat meat product, like a mixture of said cereal composite material with conventional sausage ingredients.

On the market, the Bolitas product launched in Argentina concerns a breakfast cereal for children and exists under a ball shape. The flakes integrated in this product are extruded. The reason of the use of extruded flakes is that the objective is to use said product in a liquid, wherein it preserves its integrity in said liquid.

PCT application WO 00/56171 relates to a cereal bar consisting of agglomerated particles and/or flakes of one or more cooked-extruded bases mainly comprising amylaceous materials and milk solids which are coated with a binder comprising sugar, milk solids and a binding agent. As disclosed in this document, the binder contains a water content of from 10 to 30% either added during preparation of the binder or as part of milk.

European patent application EP 1 151 676 discloses a ready-to-eat cereal bar consisting of agglomerated particles of one or more cooked cereal bases mainly comprising amylaceous materials and possibly milk solids which are coated with a binder comprising sugars, milk solids, humectants and fat. As disclosed in this document, the binder contains a water content of from 5 to 15%, either added during preparation of the binder or as part of milk.

PCT application WO 00/42867 relates to a method of making a granola bar. During the manufacture process of the granola bar, the ingredients are mixed at an elevated temperature, above 60° C., together with a liquid binder to obtain a formable mixture. The binder necessarily contains water, even when a binder with a high sugar content is desired. The granola bar disclosed in this application cannot be dispersed in a liquid to prepare a pap.

An objective of the present invention is to develop a new food product, which can be used per se as a snack or can be used in water or milk to give a pap or a porridge. Another objective of embodiments of the invention is to provide a new food product with a high cereal content. A further objective of embodiments of the invention is to provide a food product which can be manufactured easily.

The present invention concerns a cereal molded snack comprising cereal-based flakes agglomerated together with a mix of sugar and fat, wherein the cereal-based flakes are mainly roller-dried flakes.

In general, when the singular is used in this specification, it should not exclude the plural forms. For instance, “sugar” and “fat” can also mean “sugars” and “fats” respectively.

All the % given in the present specification are in weight of the uncoated snack product or of the dry mixture depending on the context.

Under “mainly roller-dried flakes”, we understand in the present specification that at least 30% of the flakes are roller-dried. The remaining flakes may be flakes obtained by other technologies well known from the man skilled in the art. For instance, non roller-dried flakes may be extruded flakes or batch-cooked flakes. In an embodiment of the invention, it is also possible to have near 100% of the flakes roller-dried. If less than 30% of the flakes are roller-dried then it becomes difficult to provide a product that is light and crispy when it is consumed as a snack and that gives a pap or porridge when the product is added to a liquid, such as water or milk.

The word “pap” relates to a semi-liquid food product obtained when adding molded cereal snack product to a liquid and that has a smooth texture. The word “porridge” relates to a food product obtained when adding molded cereal snack product to a liquid and that has a grainy texture.

The snack according to the invention is a light crispy product, meaning that it is not hard when consumed per se. It has also an internal porosity with very small gaps in between. This provides lightness and crispiness to the product.

As said before, the product according to the invention can be either consumed as such or can be poured into liquid to give a pap such as an infant pap, or a porridge. The product is preferably poured in milk or water, hot or cold. The product may also be added to other kinds of liquids such as fermented milk, liquid yogourt, broth or vegetable soup.

On the contrary, as all breakfast cereals, the above mentioned Bolitas product is developed so that it does not desintegrate within liquid.

The type of cereal in the cereal-based flakes used according to the invention is not critical. Preferably, the cereal used is wheat, corn, rice, oat, buckwheat, millet or mixtures thereof.

In an embodiment of the invention, in addition to cereals, the flakes may comprise various vegetables, fruits and mixtures thereof. Examples of vegetables are onion, carrot, potatoe, sweet potatoe, zucchini, broccoli, pumpkin, peppers, squash, okra, sweet chestnut, tomatoe and spinach. Examples of fruits are apple, pear, orange, pineapple, strawberry, raspberry, blueberry, cherry, banana, grape, pineapple, apricot, peach, fig and prune.

The total amount of cereal-based flakes is of at least 20% in weight of the snack product. More preferably, the amount of cereal-based flakes is comprised between 20 and 70%. As already specified above, at least 30% of the cereal-based flakes are roller-dried.

The product could contain also up to 15% of oat flakes. In the case of specific snack product embodiments, the product could contain up to 70% of oat flakes, including roller-dried flakes and non roller-dried flakes. The presence of oat increases the nutritional value of the snack product.

The objective of the invention is really to have a molded snack, wherein the flakes and the other ingredients of the product stick together. This is possible by the presence of sugar. Preferably, the amount of sugar is higher than the amount of fat. The type of sugar is not critical. However it seems important to use amorphous sugar. A mixture of crystalline and amorphous sugar may be used, provided that the proportion of amorphous sugar in the mixture is greater than that of crystalline sugar. In an embodiment, the amorphous sugar has a glass transition temperature lower than 100° C. Preferably, the glass transition temperature of the amorphous sugar should be in the range of about 60° C. to about 90° C., or even lower than 80° C. Preferably, the sugar used is a mono- or di-saccharide. The sugar could also be a polysaccharide such as polydextrose or other carbohydrates. If a mixture of amorphous and crystalline sugars is used, then the reference to the “glass transition temperature of the amorphous sugar” should be understood as a reference to the lowest glass transition temperature of the amorphous sugars in the mixture.

Usually, the sugar is used in powder form and is taken in the group comprising corn syrup, glucose, fructose, maltose and saccharose, or polydextrose and mixtures thereof.

In embodiments of the invention, it is also possible to include in the snack product, a certain amount of soluble fibres such as inuline. The amount of inuline is comprised between 0 and 10%.

Adjunction of fat may prove useful for various reasons. Fat may bring a desired flavour to the snack. Moreover, it improves demolding of the snack at the end of the manufacture process, i.e. after heat treatment and cooling. The amount of fat is less than 17%. If the product contains more than 17% by weight of fat, then the product becomes nutritionally unbalanced. Preferably, the amount of fat is comprised between 5 and 15%. The type of fat used is not critical. Preferably , the fat is a vegetable fat or a mixture of vegetable fats, like nut or hazelnut, in the form of paste and/or grain. Other fats may be used, such as coconut oil, cocoa butter, palm kernel oil, sunflower oil or mixtures thereof.

The water content of the molded cereal snack product is very low due to the fact that no water is used during manufacture of the snack product. In an embodiment of the invention, the snack product contains less than 5% of water, and preferably between about 1% and 2.5% of water. This range ensures a good shelf life and crispy texture of the product when consumed as a snack. Another feature of the snack product is a good shelf life which can be correlated to a low water activity (A_{w}). The molded cereal snack product usually have a water activity in the range of 0.05 to 0.40, preferably 0.05 to 0.25.

Other ingredients may be added to the snack product, such as ground or flaked nuts, dried or freeze-dried fruits or vegetables. Examples of nuts are: almond, hazelnut, cashew nut, pecan nut. Examples of dried or freeze-dried fruits are raisin, apple or berries, as well as those disclosed before as components of the flakes. Examples of vegetables or freeze-dried are cooked onion, dried tomatoe, as well as those disclosed before as components of the flakes in freeze-dried form.

The roller-dried cereal-based flakes used according to the invention have a thickness of less than 1 mm. Preferably, these flakes have a thickness comprised between 0.3 and 0.7 mm. On the one hand, it improves dispersibility of the snack in a liquid, such as milk or water. On the other hand, if the flakes are too thick, this may have a negative impact on the crispy mouthfeel of the snack product.

The snack of the invention has a strength of 1500 to 15000 g. Preferably , the strength is comprised between 2000 and 4000 g. The strength measurement is carried out with a TA-Hdi texture analyzer, having a plate of a diameter of 75 mm and working at a pre-test speed of 2 mm/s, a test speed of 1 mm/s, a post-test speed of 10 mm/s. The device has a load cell of 50 kg and a trigger force of 100 g. In order to measure the strength of a snack product, a hemispheric sample having a weight of 3 g is used. The flat surface of the hemispheric sample is placed on the measurement plate. This method is derived from a standard method “Compression Test of Food Materials of Convex Shape” published by the American Society of Agricultural and Biological Engineers, St. Joseph, Michigan (ASAE 5368.4 December 2000).

In an embodiment of the invention, the snack has a size comprised between 1 and 5 cm. Preferably, the snack has a spherical or semi-spherical form, with a diameter of around 1.5 to 2.8 cm. For instance, the snack has a half-spherical form.

The snack product may be in the form of a spherical or semi-spherical ball, each having weight of around 3 g and a density between 0.3 and 0.8 g/cm3. More generally, the weight of the snack product may be in the range of about 2 g to about 20 g. Other shapes may be imparted to the snack product. These features should not be construed as absolute limitations of the invention: they only reflect some usual sizes and shapes of snack products.

The present invention also relates to a process for the manufacture of a cereal molded snack as described above, wherein:
cereal-based flakes are dry-mixed with sugar and fat,
said mixture is molded,
the molded pieces are heat treated,
the heat treated pieces are cooled and
the cooled pieces are demolded.

As indicated above, at least 30% of the cereal-based flakes are roller-dried flakes. Moreover, the cereal-based flakes represent at least 20% of the snack product. As the snack products are obtained directly after heat treatment of the dry-mixture, the mixture also comprises at least 20% of cereal-based flakes. As can be understood from the description of the method for manufacturing the cereal molded snack, there is no water added in the mixture during the manufacture of the molded cereal snack product. Presumably, the only water contained in the mixture is the residual water content of the ingredients of the dry-mixture. Dry-mixing is carried out at ambient temperature. Ambient temperature usually ranges from 15° C. to 30° C. No heat treatment is carried out during this stage of the manufacturing process.

If desired, other optional ingredients contemplated above may be added during the dry-mixing step.

In the second step, when the mixture is molded, it means that a predetermined volume or weight of mixture is poured into the mold. The molding is a known technology: it is possible according to the invention to have directly in the same mold several hundreds of mold cavities, which allow for the manufacture of several hundreds of pieces at the same time. There again, molding of the mixture is carried out at ambient temperature.

The pieces remaining in the mold are heat treated at a temperature between 70 and 200° C. during 3 to 15 minutes. Preferably, the heat-treatment is carried out at a temperature comprised between 160 and 180° C. during 3 to 6 minutes. The higher the temperature the shorter the heat-treatment. The heat-treatment is carried out so that the sugar starts to melt. Preferably, the heat treatment is carried out at the glass transition temperature of the sugar or the lowest glass transition temperature of sugar mix, or at a higher temperature. Thus a satisfactory repartition of the sugar may be achieved in the molded cereal product. As indicated before, the sugar may comprise in fact a mixture of various carbohydrates, in the amorphous form and optionally in the crystalline form.

After the heat treatment, the snack product is cooled, for instance in a cooling tunnel. Usually, air at a temperature in the range of about 12° C. to about 20° C. is blown in the tunnel. Cooling usually lasts between 10 and 30 minutes depending on the size of the snack product and surrounding air temperature. During cooling, it is assumed that the sugar solidifies back thus forming a kind of cement between the other ingredients of the molded cereal snack product. Thus, the various ingredients of the molded cereal snack product are glued together. In an embodiment, cooling is carried out at a temperature around 20° C.

In a snack specific embodiment of the molded cereal product, the cooled snack product may undergo further treatment prior to packing. Such treatment may be an coating, for instance with chocolate. The coating may be provided on top of the snack product, all around it or simply on the bottom of the snack product. Various methods are known to provide a coating. Usually the coating is applied in a liquid form on the snack product, then a further cooling occurs in order to solidify the coating on the snack product. Coating may be performed by various well known techniques such as dipping, dripping, spraying or enrobing. When the snack product has a coating, then only the uncoated snack product is to be considered for computing the weight ratios or percents.

In another aspect, the invention also relates to a premix of ingredients that is provided to the end-user, be it a manufacturer or a consumer, together with use instructions for the premix. This premix comprises the various ingredients already mentioned above for the manufacture of a molded cereal snack product. The said ingredients premix could also be comprised in a kit-of-parts comprising also a mold and use instructions for the premix and the mold.

The following of the specification is made in relation with specific examples. In the examples, percentages are by weight.

### EXAMPLE 1

45% of roller dried wheat flakes are mixed with 10% oat flakes, 36% of sugar in powder form, 9% of hazelnut paste in a Hobart mixer.

Teflon moulds with half-spherical shaped cavities are filled with this mix. The mix is cooked 10 min. at 200° C. Then moulds are let to cool down during 30 minutes at 20° C. and the product is demolded and then packed.

The cereal snack balls have a strength of around 2200 g.

### EXAMPLE 2

36% of roller dried wheat flakes are mixed with 15% oat flakes, 36% of amorphous sucrose in powder form, 13% of hazelnut paste in a Hobart mixer.

Teflon moulds with half-spherical shaped cavities are filled with this mix. The mix is cooked 5 min. at 190° C. Then moulds are let to cool down during 30 minutes at 20° C. and the product is demolded and then packed.

### EXAMPLE 3

34% of roller dried wheat flakes are mixed with 20% of orange powder, 18% of amorphous powdered sucrose, 18% of amorphous powdered glucose and 10% of cocoa butter in a Hobart mixer.

Teflon moulds with half-spherical shaped cavities are filled with this mix. The mix is cooked 5 min. at 190° C. Then moulds are let to cool down during 30 minutes at 20° C. and the product is demolded and then packed.

### EXAMPLE 4

30% of roller dried wheat flakes are mixed with 15% oat flakes, 6% of freeze-dried strawberries, 36% of amorphous sucrose in powder form, 13% of hazelnut paste in a Hobart mixer.

Teflon moulds with half-spherical shaped cavities are filled with this mix. The mix is cooked 5 min. at 190° C. Then moulds are let to cool down during 30 minutes at 20° C. and the product is demolded and then packed.

### EXAMPLE 5

36% of roller dried wheat and carrot flakes are mixed with 15% oat flakes, 36% of amorphous sucrose in powder form, 13% of hazelnut paste in a Hobart mixer.

Teflon moulds with half-spherical shaped cavities are filled with this mix. The mix is cooked 5 min. at 190° C. Then moulds are let to cool down during 30 minutes at 20° C. and the product is demolded and then packed.

The products of examples 1, 2, 3, 4 and 5 could be used directly as a ready-to-eat snack. Furthermore, in order to prepare a pap or a porridge, 8 pieces of molded cereal based product (approximately 32 g) made according to examples 1,2,3,4 and 5 were added to 100 mL of milk or water. In each assay, a pap (examples 1,2,3 and 5) or a porridge (example 4) was easily prepared. The product pieces could easily disintegrate in the liquid. To obtain a thicker or thinner pap or porridge, the amount of snack product is increased or reduced with respect of the amount of liquid.

Thus, the invention provides for an easily proportionable product for preparing a pap or porridge upon addition in liquid such as water or milk.

1. A molded cereal snack comprising cereal-based flakes agglomerated together with sugar and fat, at least 30% of the cereal-based flakes are mainly roller-dried flakes.

2. A molded cereal snack according to claim 1, wherein the cereal is selected from the group consisting of wheat, corn, rice, oat, buckwheat, millet and mixtures thereof.

3. A molded cereal snack according to claim 1, wherein the amount of cereal-based flakes is at least 20% in weight.

4. A molded cereal snack according to claim 1, wherein close to 100% of the flakes are roller-dried flakes.

5. A molded cereal snack according to claim 1, wherein the amount of sugar is greater than the amount of fat.

6. A molded cereal snack according to claim 1, wherein the amount of fat is less than 17%.

7. A molded cereal snack according to claim 1, wherein the roller-dried cereal-based flakes have a thickness of less than 1 mm.

8. A molded cereal snack according to claim 1, wherein the snack has a strength of 1500 to 15000 g.

9. A molded cereal snack according to claim 1 wherein the sugar comprises amorphous sugar.

10. A process for the manufacture of a molded cereal snack comprising:
mixing mainly roller-dried cereal-based flakes with sugar and fat,
molding the mixture,
heating the molded pieces,
cooling the heat treated pieces, and
demolding the cooled pieces.

11. A process according to claim 10, wherein the heat-treatment is performed at a temperature between 70 and 200° C. during 3 to 15 minutes.

12. A process according to claim 10, wherein the cooling takes place at a temperature of about 12° C. to about 20° C.
